(19) United States
(12) Patent Application Publication
(10) Pub. No.: US 2020/0285637 A1
(43) Pub. Date: Sep. 10, 2020

(54) METHOD AND SYSTEM FOR INFORMATION VISUALIZATION AND DIGITAL INTERACTIONS FOR ENTERPRISE APPLICATIONS ON BLOCKCHAIN

(71) Applicant: Conduent Business Services, LLC, Florham Park, NJ (US)

(72) Inventors: Jayati Bandyopadhyay, Bangalore (IN); Avantika Gupta, Bangalore (IN); Ashwini Marathe, Nagpur (IN); Sitara Shah, Bangalore (IN); Krishnaprasad Narayanan, Bangalore (IN)

(21) Appl. No.: 16/291,925

(22) Filed: Mar. 4, 2019

(51) Int. Cl. G06F 16/248; G06F 16/27; G06F 3/0481

(52) U.S. Cl. CPC G06F 16/248; G06Q 20/389; G06F 3/0481; G06F 16/27

(57) ABSTRACT

A method and system for visualizing a distributed ledger data structure and business and network transactions thereof can include identifying business transactions and assets in ledger data contained in a ledger data structure, and translating the identified business transactions and the identified assets into visual elements that can visually represent asset states in a process involving the ledger data structure and transactions thereof.

### TECHNICAL FIELD

Embodiments are generally related to blockchains and in particular to blockchain related transactions. Embodiments further relate to the visualization of blockchain related transactions.

### BACKGROUND

Blockchain technology was developed as a way of providing a publicly transparent and decentralized ledger that can be configured to track and store digital transactions in a publicly verifiable, secure, and hardened manner to prevent tampering or revision.

A typical blockchain can include three primary functions: read, write, and validate. For example, a user of the blockchain should have the ability to read the data that resides on the blockchain. A user of the blockchain should also have the ability to write (e.g., append) data to the blockchain. Every write operation starts out as a proposed transaction that can be posted on the network. The proposed transaction may not always be valid, for example, it may be malformed (e.g., syntax errors), or it may constitute an attempt to perform a task for which the submitter is not authorized. Validation in this context can relate to filtering out invalid transactions and then deciding on the exact order for the remaining, valid, transactions to be appended to the blockchain. This process is often referred to as “consensus”.

Once ordered, the transactions can be packaged into blocks, which in turn can be appended to the blockchain. Each new block that is appended to the blockchain can also include a hash of the previous block. Accordingly, as each new block is added, the security and integrity of the entire blockchain can be further enhanced. It is important to note that once data is written to the blockchain, for example, once a block including transactions has been appended to the blockchain, that data can no longer be altered or modified. In a typical blockchain, the anonymity of the users can be protected through the use of pseudonyms and the transaction data itself can be protected through the use of cryptography, e.g., via the use of hash codes.

Recently, the use of blockchain technology has expanded beyond crypto currency, to provide a framework for the execution of smart contracts. Smart contracts are self executing agreements between parties that have all of the relevant covenants spelled out in code, and settle automatically, depending on future signatures or trigger events. By leveraging blockchain technologies, smart contracts, once appended to the blockchain, may not be revoked, denied, or reversed, since decentralized execution may remove them from the control of any one party.

The benefits of blockchain based solutions are well understood in the research and technology communities, but its adoption in the business realm has not seen substantial success. Because blockchain (or “Blockchain”) can be primarily a backend technology, it limits the scope for business users to effectively distinguish between business process solutions implemented on legacy systems and blockchain based applications. The textual information displayed on a surface layer of such solutions, for example, fails to set forth the benefits of blockchain. An effective way to communicate the benefits of blockchain based applications may be to visualize the end-to-end view of business processes, transparency in transactions across stakeholders, which current legacy systems fail to offer.

Current blockchain based systems do not offer sufficient support for business transaction visualizations. A typical conventional blockchain explorer, for example, caters to network based transactions. This approach may display only rudimentary information such as the name of the sender and the receiver of a transaction, a timestamp and a few block characteristics. These explorers fail to cater to business needs, as it does not capture information about the contracts, assets and associated entities, and stakeholders.

Existing approaches for blockchain visualizations focus on displaying the network characteristics. Such systems cater only to displaying rudimentary information such as sender and receiver of the transaction, timestamp and the block characteristics, as discussed above. It is to be noted that for enterprises, having only a network visualization is not a sufficient solution because it does not show information about the contracts/assets and their exchanges with their clients/stakeholders.

Building a visualization framework representing an application flow (e.g., interactions between the stakeholders with information exchange) on blockchain is a difficult task because the data is not provided in a human-readable format, which does not allow for a direct translation to the visualization layer. In addition, preserving the “Blockchain-ness” (e.g., preserving selective visibility, contract creation, etc), while translating the modified process on blockchain to the visualization layer is challenging. Also, representing the various forms of stakeholder engagement (e.g., approve/reject, acknowledgement, negotiation, etc), and mapping the different states of an asset in the process flow is complex in and of itself.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide a method and system for visualizing a ledger data structure and transactions thereof.

It is another aspect of the disclosed embodiments to provide for a method and system for the visualization of blockchain transactions.

It is still another aspect of the disclosed embodiments to provide for a method and system that supports blockchain related transaction visualizations.

It is a further aspect of the disclosed embodiments to provide for an interactive, visual format, which facilitates a holistic interpretation of all blockchain related transactions for the involved stakeholders.

The aforementioned aspects and other objectives and advantages can now be achieved as described herein. A method and system for visualizing a ledger data structure and transactions thereof are disclosed herein. In an embodiment, the method and system can involve identifying transactions and assets in ledger data contained in a ledger data structure, and translating the identified transactions and the identified assets into visual elements that visually represent asset states in a process involving the ledger data structure.

The disclosed embodiments can be implemented as a use-case and platform agnostic method and system for structuring information and visualizing asset exchanges across stakeholders. This approach can offer a role-based, personalized and interactive interface for stakeholders to effectively assess and interpret the processes and transactions. The disclosed embodiments can involve identifying generic transactions and assets across use-cases. These transactions can be further translated into unique visual elements for effective representation of different asset states throughout a process flow.

The disclosed embodiments can further implement a visual and interactive mechanism for depicting transactions on blockchain, thereby allowing stakeholders to obtain a unified view of business and other processes.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of a visualization system, which can be implemented in accordance with an embodiment;

FIG. 2 illustrates a block diagram of a visualization layer architecture, which can be implemented in accordance with an embodiment;

FIG. 3 illustrates a graphical diagram depicting a GUI (Graphical User Interface) that displays a panoramic visualization in accordance with an embodiment;

FIG. 4 illustrates a block diagram that depicts an extended view of panoramic visualization in accordance with an embodiment;

FIG. 5 illustrates a schematic diagram depicting a graph module example for a procure-to-pay use-case in accordance with an embodiment;

FIG. 6 illustrates a block diagram depicting guide elements in accordance with an embodiment;

FIG. 7 illustrates a block diagram depicting an engagement dictionary in accordance with an embodiment;

FIG. 8 illustrates a block diagram of a network view in accordance with an embodiment;

FIG. 9 illustrates a schema for a configuration database in accordance with an embodiment;

FIG. 10 illustrates a schema for an explorer database in accordance with an embodiment;

FIG. 11 illustrates API (Application Programming Interface) output for a panoramic view in accordance with an embodiment;

FIG. 12 illustrates API output for an inline view in accordance with an embodiment;

FIG. 13 illustrates a block diagram depicting the deployment of a system in accordance with an embodiment;

FIG. 14 illustrates a schematic diagram of a negotiation process flow for a procure-to-pay use case in accordance with an embodiment;

FIG. 15 illustrates a visual representation of a procure-to-pay process flow in accordance with an embodiment;

FIG. 16 illustrates a schematic view of a computer system, in accordance with an embodiment; and

FIG. 17 illustrates a schematic view of a software system including a module, an operating system, and a user interface, in accordance with an embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Several aspects of data-processing systems will now be presented with reference to various systems and methods. These systems and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A mobile “app” is an example of such software.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer.

By way of example, and not limitation, such computer-readable media can include read-only memory (ROM) or random-access memory (RAM), electrically erasable programmable ROM (EEPROM), including ROM implemented using a compact disc (CD) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), and floppy disk where disks usually reproduce data magnetically, while discs reproduce data optically with lasers. Combinations of the above should also be included within the scope of computer-readable media.

As will be discussed in greater detail herein, the disclosed embodiments include a use-case and platform agnostic system for structuring business information and visualizing asset exchanges across stakeholders. This approach offers a role-based, personalized and interactive interface for stakeholders to effectively assess and interpret the business processes and transactions. The disclosed embodiments involve identifying generic transactions and assets across business use-cases.

These transactions can be further translated into unique visual elements for effective representation of different asset states throughout the process flow. The disclosed embodiments include a visual and interactive mechanism that can depict the business transactions on Blockchain, thereby allowing stakeholders to obtain a unified view of business processes.

The disclosed visualization framework includes a system that visualizes transactions on blockchain. Such transactions can be configured using smart contracts. The transactions can also be represented by a flow of assets across entities. Such transactions may be rendered differently for different roles. Entities (e.g., stakeholders) can interact with different elements of visualization for subsequent queries. In addition, the disclosed embodiments include a visualization layer that is dynamic and which can be updated in real-time to capture state changes of the assets. The identified transactions are use-case agnostic and also agnostic of existing Blockchain platforms. In addition, an “event listener” can be configured to act as a gateway, which also renders the system platform agnostic.

The disclosed embodiments involve the identification of generic business transactions, and a system architecture with its individual modules. In addition, generic transactions identification can involve identifying generic business transactions to derive an use-case agnostic visualization with plug-and-play capabilities. One objective can involve analyzing cross-domain business transactions and generalizing these transactions to cater to a plethora of use-cases.

Two different types of transactions can be identified during this process: transactions with single stakeholder, and transactions with multiple stakeholders. A single stakeholder transaction may not necessarily have an asset association. For business transactions with two or more stakeholders, an asset association may be implicit.

Transactions in a network can be classified into: Stakeholder Based Engagements (SBE, single stakeholder, may or may not be mapped to an asset), Asset Based Engagements (ABE, multiple stakeholders, must be mapped to an asset). While Asset Addition can be identified to be a SBE, Asset Modification/Deletion can be categorized as both ABE and SBE, depending on whether the asset under consideration is bound by an existing contract. The transactions can be categorized by “Contract Status” (e.g., Pre-Contract Transactions and Post-Contract Transactions). This categorization can be used to define the different engagements as discussed herein.

A list of example identified SBEs and ABEs is listed in Table 1 below. Each of these identified transactions can be then mapped back to two use-cases, Procure-to-Pay and Insurance to assess their generic-ness. Almost all the transactions can be mapped as-is to the use-cases as shown in Table 1 below.

TABLE 1
Stakeholder and Asset Based Engagements

| | Contract | Procure-to-Pay | Insurance |
|---|---|---|---|
| Asset Definition | Status | Part/Line Item | Policy |
| Stakeholder based | | | |
| (single stakeholder) | | | |
| Network | Pre-Contract | As-Is | As-Is |
| Onboarding | | | |
| Independent Asset | NA | As-Is | As-Is |
| Deletion/Modification | | | |
| Asset Addition | NA | As-Is | As-Is |
| Asset based (multipile | | | |
| stakeholders | | | |
| Engagement Request | Pre-Contract | Procurement | Enrollment |
| | | Request | Request |
| Verification/KYC | Pre-Contract | Supplier | Credentialing |
| | | Verification | |
| Negotiation | Pre-Contract | As-Is | As-Is |
| Contract Creation/ | Post-Contract | As-Is | As-Is |
| Deletion/Modification | | | |
| Contract Invocation | Post-Contract | Order Release | Claims |
| Dependent Asset | Post-Contract | As-Is | As-Is |
| Deletion/Modification | | | |

Note that the term procure-to-pay or P2P as utilized herein can relate to a subdivision of a procurement process. A procure-to-pay system can facilitate the integration of the purchasing department with an accounts payable (AP) department. The steps of a procure-to-pay process can include, for example, supply management, cart or requisition, purchase order, receiving, invoice reconciliation, and accounts payable Unlike source-to-play systems, procure-to-pay systems do not include the function of sourcing. Also, notions of production planning and forecasting may be excluded from this definition since it relates to supply chain management. Enterprise applications may implement procure-to-play systems and processes. A business process may include a sequence of transactions from beginning to end. Enterprise applications may create and store a document in memory for each transaction of the sequence. For example, a procure-to-pay business process may include a sequence of transactions that result in the creation of a requisition order, a purchase order, a receipt, a voucher, and a payment. Each document may store data relevant to its corresponding transaction.

The term “blockchain” or “Blockchain” as utilized herein relates to a growing list of records, referred to as blocks, which an be linked using cryptography. Each block can contain a cryptographic hash of the previous block, a timestamp and transaction data (e.g., represented as a merkle tree root hash). A blockchain is resistant to modification of the data, and is an open, distribute ledger than record transactions between two parties in an efficient, verifiable and permanent manner. For use with a distributed ledger, a blockchain can be managed by a peer-to-peer network collectively adhering to a protocol for inter-node communication and validating new blocks. Once recorded, the data in any given block cannot be altered retroactively without alteration of all subsequent blocks, which requires consensus of the network majority. Although blockchain records may not be unalterable, blockchains may be considered secure by design and can exemplify a distributed computing system with high Byzantine fault tolerance. An example of blockchain is disclosed in “Bitcoin: A Peer-to-Peer Electronic Cash System,” by Satoshi Nakamoto, which is incorporated herein by reference in its entirety. A blockchain can be implemented as a blockchain platform, examples of which include Hyperledger and Etherium.

The term “smart contract” as utilized herein relates to a computer protocol intended to digitally facilitate, verify, or enforce the negotiation or performance of a contract. Smart contracts allow the performance of credible transactions without third parties. These transactions can be trackable and irreversible. As will be discussed in further detail herein, transactions may be generic across a group of existing blockchain platforms. That is, the identified transactions may be generic across existing blockchain platforms such as Hyperledger or Etherium.

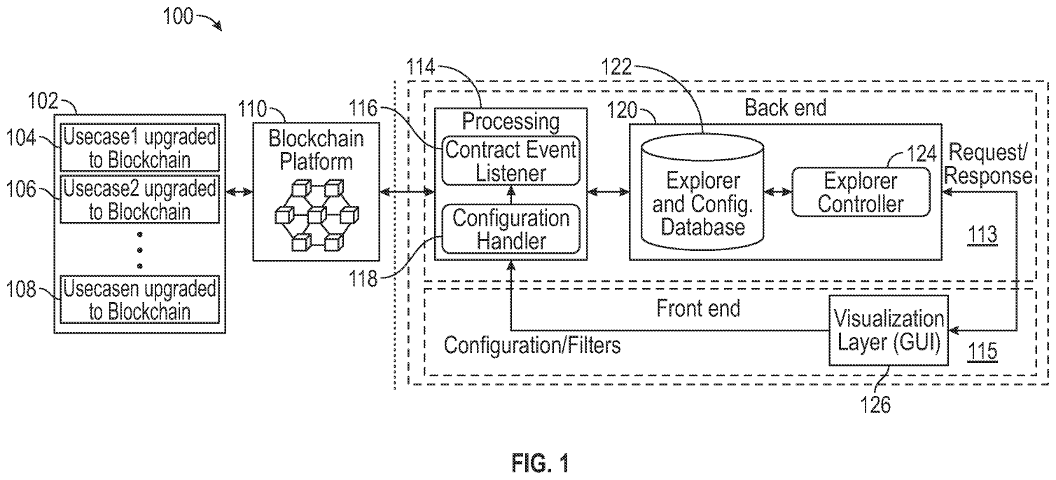

FIG. 1 illustrates a block diagram of a visualization system 100, which can be implemented in accordance with an embodiment. The visualization system 100 can include use cases 102 which can be provided to a blockchain platform 110. The blockchain platform 110 (e.g., a blockchain network) can also provide data to the use cases 102. As shown in FIG. 1 the use cases 102 can include a first use case 104 involving an upgrade to a blockchain, along with a second use case 106, which can also involves an upgrade to the blockchain, and additional use cases such as an n^{th} use case 108, also involving an upgrade to the blockchain.

The visualization system 100 can further include a back-end system 113 and a front-end system 113. The back-end system (or “back-end layer”) 113 can include a processor 114 that includes a contract event listener 116 and a configuration handler 114. The back-end system 113 can further include a controller module 120 that can include an explorer and configuration database 122 and an explorer controller 124. The explorer and configuration database 122 and the explorer controller 124 can communicate with one another. The explorer controller 124 can provide data for storage in the explorer and configuration database 122 and can also retrieve data from the explorer and configuration database 122.

Note that the term “event listener” or “Event Listener” as utilized herein can relate to a procedure or function in a computer program that waits for an event to occur. The event listener can be programmed to react to an input or signal calling an event's handler. In some instances, the term event listener may be specific to Java and JavaScript. In other languages, however, a subroutine that can perform a similar function may be referred to as an event handler. Thus, the terms “event handler” and “event listener” may refer to the same procedure or function.

The front-end system (or “front-end layer) 115 can include a visualization layer 126, which may be, for example, a GUI (Graphical User Interface) that outputs configurations/filters, which can be input to the processor 114 of the back-end system 113. The controller module 120 and the visualization layer 126 can both be subject to a request/response, as shown in FIG. 1.

FIG. 1 thus illustrates the architecture of a visualization framework. That is, the visualization system 100 provides a visualization framework including a visualization layer. The visualization layer 126 can include a graph module, an explorer module and a customization module as will be discussed in greater detail herein.

The backend system 113 for the framework can be motivated by the contract event listener 116. The data from Blockchain can be ingested and processed using this component, and stored and maintained in the explorer and configuration database 122. The configuration handler 118 can initiate listening for specific events that are associated with the underlying contracts. Assets, associated contracts (e.g., transactions) and their events will be described in greater detail herein. For now, it is noted that at runtime, the explorer controller 124 can use APIs/interfaces defined in the explorer controller 124 to populate information in the visualization layer 126.

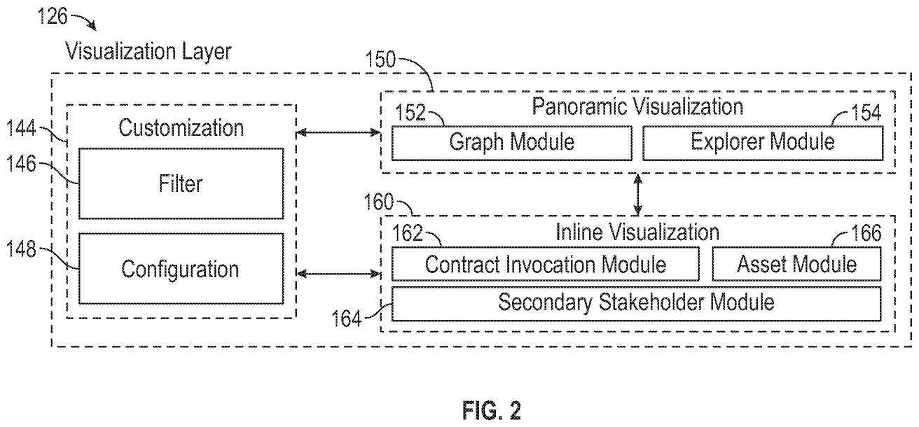

FIG. 2 illustrates a block diagram of the architecture of the visualization layer 126, in accordance with an embodiment. The visualization layer 126 can include a customization module 142, a panoramic visualization module 150, and an inline visualization module 160. The panoramic visualization module 150 includes a graph module 152 and an explorer module 154. The inline visualization module 160 can include a contract invocation module 162, an asset module 166, and a secondary stakeholder module 164.

The incorporation of business visualization is two-fold as shown in FIG. 2. The inline visualization module 160 can present a combination of real-time and historic data of individual asset status or stakeholder transaction status and can be integrated with all the application sections. The panoramic visualization module can portrays a summary of all real-time transaction-states across multiple assets or stakeholders in the graph module 152 and a combination of real-time and historic transactions in the explorer module 154. The customization module 144 can act as an additional interactive layer that assists users in customizing the content of the visualization modules through the use of a filter module 146 and a configuration module 148.

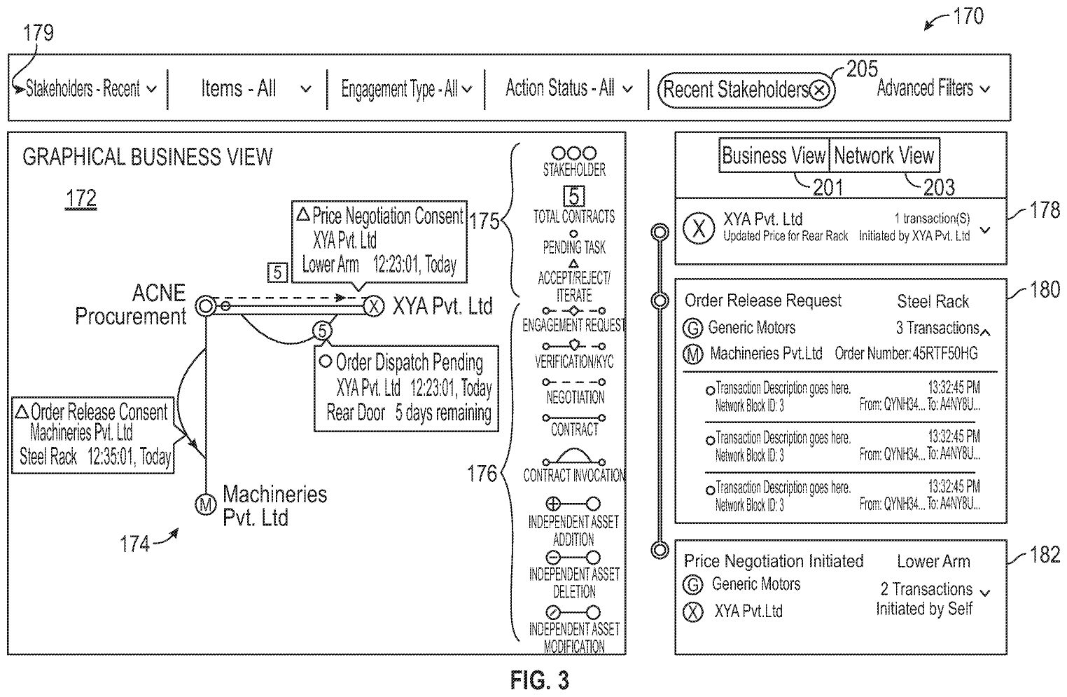

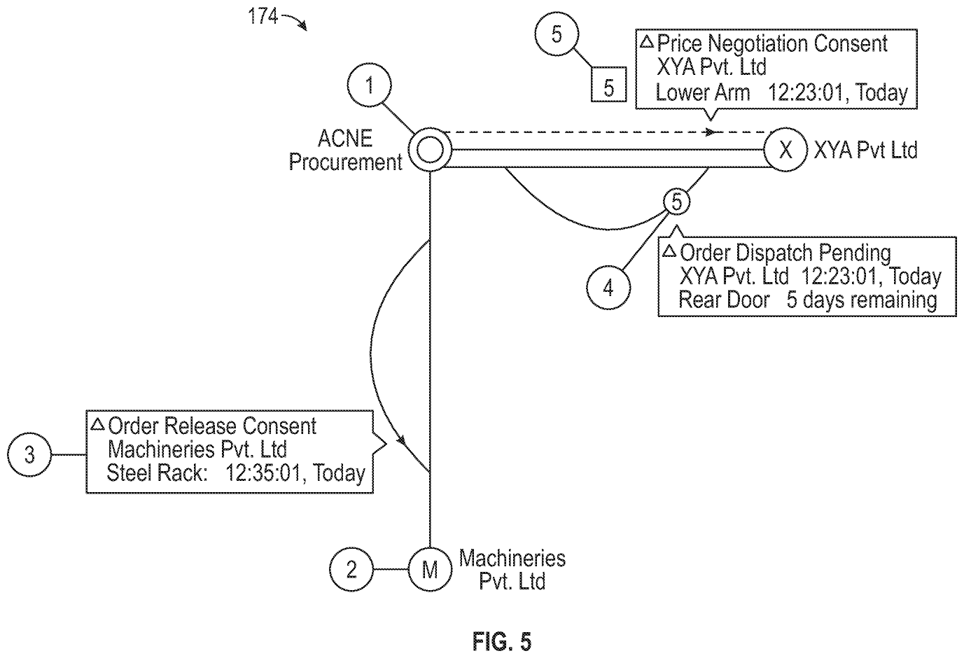

FIG. 3 illustrates a graphical diagram depicting a GUI (Graphical User Interface) 170 that displays a panoramic visualization in accordance with an embodiment. The panoramic visualization can be implemented according to instructions provided by the panoramic visualization module 150 shown in FIG. 2. The example GUI 170 includes a GUI section 172 that can display a graphical business view in response to a user selection of a “Business View” GUI button 201. In the example shown in FIG. 3, the business view displayed in the GUI section 172 is a graph module view 174 of a procure-to-pay use case, which is also shown in FIG. 5. In the right hand side of the GUI section 172, various guide elements 175 and 176 are graphically displayed in association with the graph module view 174 displayed in the GUI section 172.

The GUI 170 also displays other GUI sections and GUI buttons and widgets such as a “Network View” GUI button 203, a GUI section 178 that can display transaction data, a GUI section 180 that can display order release request data, and a GUI section 182 displays price negotiation initiated data, and so on. In addition, the GUI 170 can include a GUI section 179 that provides for various filters that can be selected or deselected by a user of the GUI 170. An example of a filter is the filter button 205, which when selected by the GUI user, can limit the data presented in the GUI section 172 to, for example, data related to recent stakeholders.

The visualization provided in GUI 170 can be implemented as a stand-alone summary view showcasing all real-time business transactions across stakeholders. The GUI 170 allows users to interact with visualization elements and drill down further into each transaction detail. The panoramic visualization provided GUI 170 can include a graphic view and a time-stamped block view of the transactions, which and are described in greater detail herein. Owing to the modular nature of the visualization module 150, the system 100 allows for flexibility in terms of its addition or deletion in the application without affecting business and backend layers.

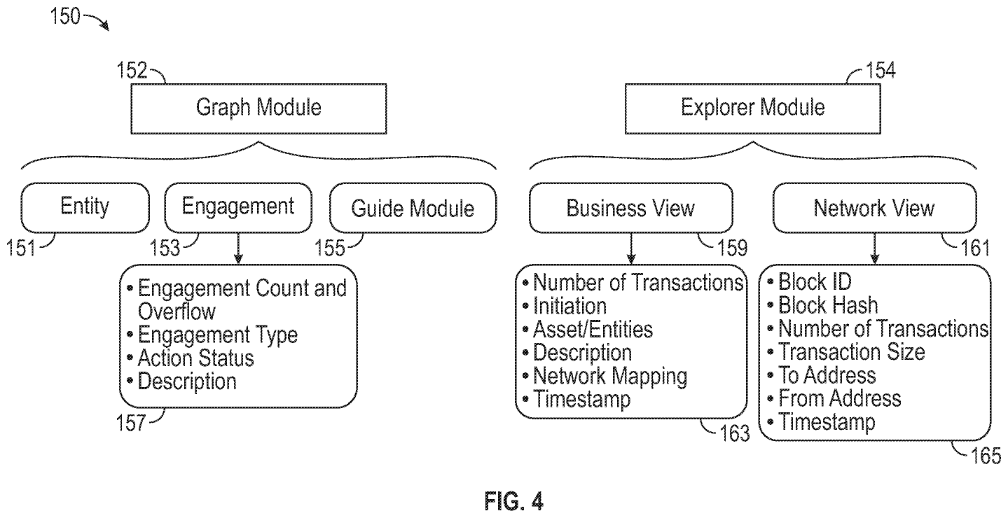

FIG. 4 illustrates a block diagram that depicts an extended view of the panoramic visualization module 150 in accordance with an embodiment. As discussed previously, the panoramic visualization module 150 can include a graph module 152 and an explorer module 154. These modules can broken down into further components and modules as shown in FIG. 4.

The graph module 152 can function as the core of panoramic visualization. The graph module 152 can represents the current state of all transactions across stakeholders through a two-dimensional directed graph. The building blocks of the graph module 152 can be derived from basic graph theory elements and can be designed with an active effort to minimize the complexity of the visual presentation. In some embodiments, the number of elements can be kept considerably low to help reduce a users' learning time.

The graph module 152 can include a guide module 155 that provides spontaneous reference support to help users interpret the different asset states. The visualization renders elements based on the role of the signed-in individual, which can be explicitly defined in the configuration module 148 by, for example, an application administrator.

The content of the panoramic view can also vary based on the organization hierarchy. For example, in a Procure-to-Pay scenario such as shown in FIG. 5, an employee managing a procurement of 100 items may only be shown those items, contracts and orders pertaining to those items and existing suppliers supplying those items. For any contract negotiation for one or more items, the employee can be shown existing as well as potential suppliers.

The graph module 152 can also include an entity module 151, which provides the node or the vertex of the graph, termed as the ‘Entity’, which can represent different stakeholders in a blockchain network. Stakeholders can represent different business entities or organization and are configurable to the role of an individual within the organization. The signed-in individual may be considered to be the primary stakeholder (e.g., see 1 in FIG. 5) across all renders of the visualization. The point-of-view can be, thus, pivoted around the Primary Stakeholder (PS). The primary stakeholder's real-time interactions with other business entities can contribute to the content of the graph. All other business entities directly interacting with the PS can be termed as Secondary Stakeholder (SS). These secondary stakeholders can be distributed around the PS and have clear markers (e.g., business entity name, business branding or colors, 2 in FIG. 5) to help users distinguish between multiple entities. They can be displayed or hidden depending on the timestamp of their last interaction with the PS. This is to ensure that the graph has a manageable number of nodes to avoid clutter.

The graph module 152 also includes an engagement module wherein the edge joining the PS and SSs represent the stakeholder engagements. These engagements can represent bounding contracts or contract possibilities between the connecting business entities. Multiple edges may be possible between any two stakeholders, representing an engagement types such as an active contract or a negotiation. At any point in time, stakeholders with any active engagement with the PS can be made visible in the graph (e.g., via a GUI button such as the GUI button 205 shown in FIG. 3).

An “Engagement Type” as shown in block 157 can thus include different variations of edges, which can denote different engagement types between stakeholders. All engagements can be mapped to unique edge variations. Stakeholder based transactions such as independent asset modification/deletion can be derived from the self-loop or buckle element in graph theory. Dependent asset modification/deletion can be considered to be modifications to an already existing contract between the PS and an SS and can be represented by ‘Consent for Engagement’ action status.

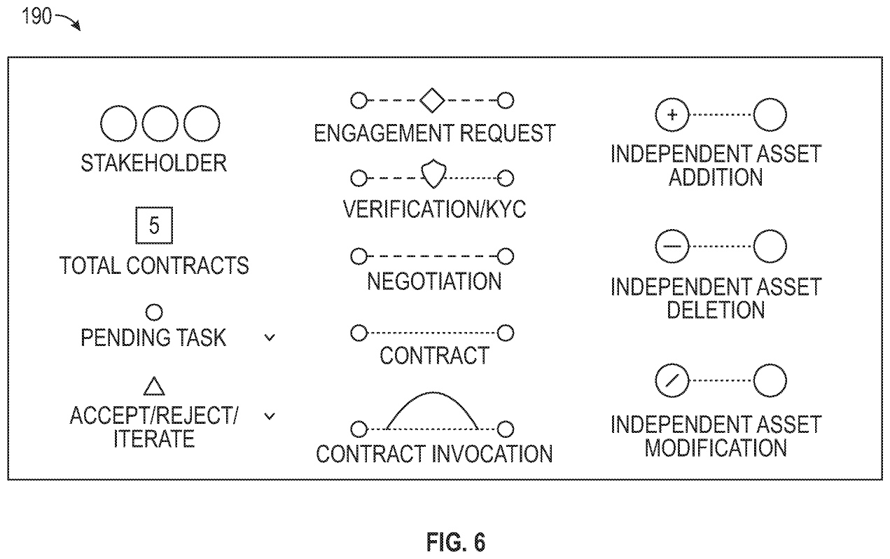

Examples of diagrammatic representations of all the above-mentioned engagements in form of an Engagement Dictionary are documented in FIG. 6. The visibility of each Engagement Type can be configured in the configuration module 148. For example, engagements such as network on-boarding can be made visible to an administrator role. ABEs such as Verification/KYC can be made visible to the business entity performing the verification along with the PS.

“Engagement Count and Overflow” as shown in block 157 can involve instances where any two stakeholders have more than 3 active engagements. An overflow indicator (e.g., 5 in FIG. 5) can appear to highlight the total number of engagements between the two stakeholders. On-hover, the indicator can display the list of all active contracts, with whom are the actions pending with, their Engagement Types, last action timestamp, and action status.

“Action Status” as shown in block 147 can be a visualization that differentiates between different types of pending actions, namely ‘Consent for Engagement’ (Accept/Reject/Iterate) and ‘Outcomes of Engagement’ (pending task). Note that a ‘Consent for Engagement’ type of action seeks consent from one or more stakeholders. Consent decisions can drive outcomes of an engagement. In the Procure-to-Pay scenario, a supplier can accept, reject or negotiate (e.g., time, cost, quantity) orders placed by a buyer. If the supplier accepts the order, one such outcome for a supplier may be to complete the pending task of dispatching goods and move the process ahead in the workflow.

Any ‘Consent for Engagement’ on the ABEs may be represented by an arrow, the position and direction of the arrow highlighting the stakeholder with whom the consent is pending. If the stakeholder accepts the request, the marker can change to a pending task (circle), which may be the desired outcome of the current stage (dispatch goods) in the workflow. An additional option of SLA time can be configured (e.g., 4 in FIG. 5) for each action type to communicate the health of an engagement.

“Description” as shown in block 157 can involve “hovering” on the Engagement or the Action Status arrow or circle displays a description of the engagement and the pending action (e.g., 3 in FIG. 5). For example, a user may be permitted to interact with different visual elements without supplying a query. For example, hovering on the edge joining two nodes can provide contract details. Note that the terms “hover” or “hovering” as utilized herein relate to a GUI feature, sometimes referred to as mouse over, mouse hover or hover box, which relates to a GUI control element that can be activated when the user moves or “hovers” the GUI pointer over a trigger area.

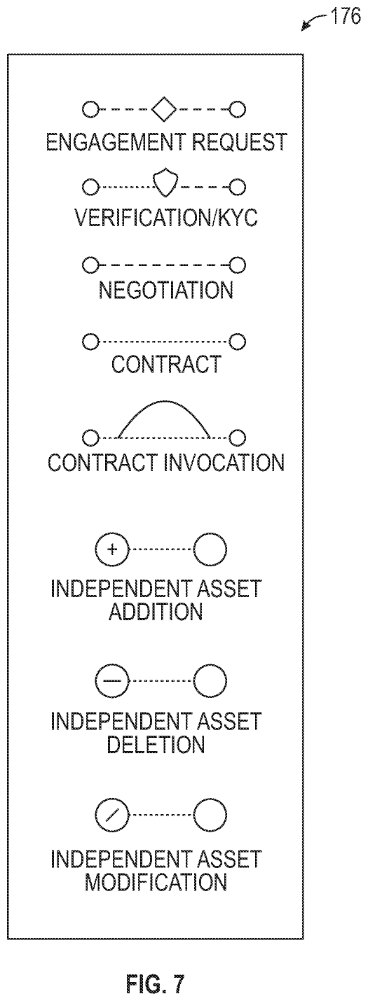

The guide module 155 can provide spontaneous reference support to help users interpret the different asset states. A detailed listing of the guide elements is shown in FIG. 7.

The explorer module 154 can act as a supporting component for the graph module that records and displays each transaction on the network. These transactions can be grouped either by their business activity attribute or their timestamp and size attributes, depending on the view selected by the PS. The explorer module can provide a business view 159 or a network view 161, which can be selected by a user with GUI buttons such as the respective GUI buttons 201 and 203 shown in FIG. 4.

The business view 159 can provide the number of transactions, initiation data, asset/entity data, description information, network mapping, and timestamps, as shown in block 163. The business view module 159 of the explorer module can be used to represent the sequence of business transactions occurring in the network, translating and extending the block-transaction coupling implemented in the existing platform network explorers described in the related work section. Each block in the explorer module can represents a high-level business activity, represented by the Engagement Types explained in the Graph Module. Each Engagement Type can be expected to include a series of transactions. This module can collate all the connected transactions within a block (representing one Engagement Type) and represents them as time-stamped series of blocks.

Each block can either be Entity Driven (for Stakeholder Based Engagements) or Asset Driven (for Asset Based Engagements) depending on the Engagement Type. The “Number of Transactions” shown in block 163 can relate an element denoting the total number of transactions (representing a business activity) in each block. “Initiation” as shown in block 163 can relate to each business activity that may need to be initiated by a stakeholder, each PS (denoted by Self) or the secondary stakeholder. The network address of the stakeholders (To and From) can be also embedded for each transaction with a block. “Entities” (Asset Based) as shown in block 163 relates to two or more stakeholders who may be required to be associated with a business activity for Asset Based Engagements. “Asset” (Stakeholder Based) as shown in block 163 can relate to a Stakeholder Based Engagement, since there may be a possibility of an asset association. Since, a SBE may or may not be associated with an asset, this element may be optional.

“Timestamp” as shown in block 163 relates to the fact that each transaction has an associated timestamp, which can determine the ordering of the blocks and the corresponding transactions with each block. “Network Mapping” as shown in block 163 relates to the fact the each transaction can be mapped to the network block ID and can be included for faster reference. Network Mapping is the only element that connects the business and the network views. “Description” as shown in block 163 relates to the fact that all transactions can be accompanied by an activity level description for a better understanding of the context.

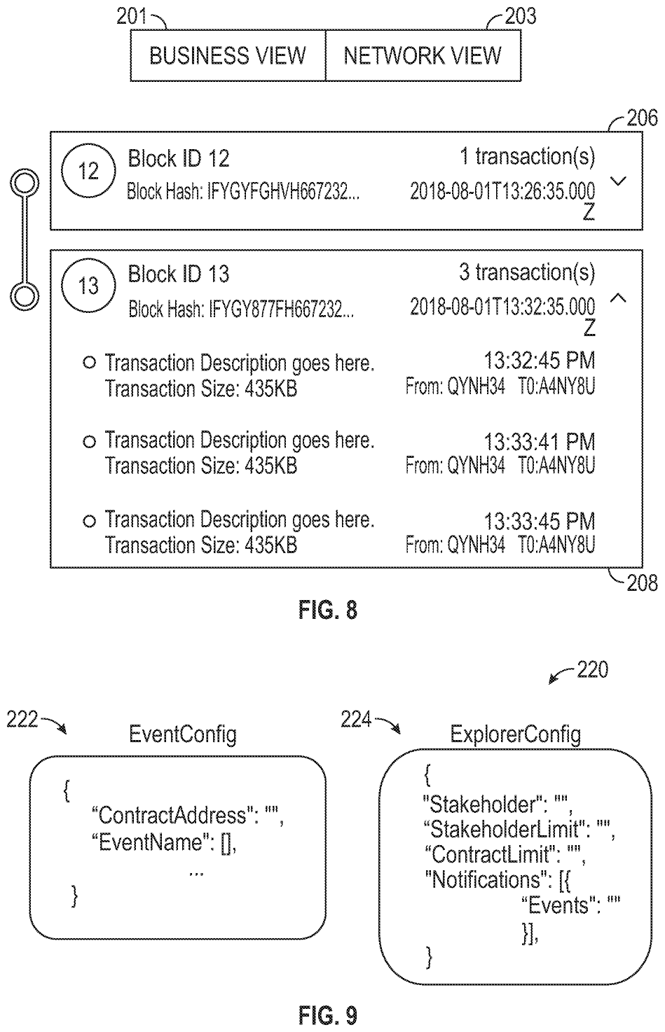

The network view module 161 can be selected to display network blocks and their transactions (e.g., see FIG. 8) as an “as-is” version of the current platform explorer views. The network view module 161 can provide for elements such as Block ID, Block Hash, Block Creation Timestamp, Number of Transactions in the block, the network addresses associated with the transactions and the transaction size, and so on as shown in block 165. The network view provided by the network view module 161 can be configured to additionally support the network roles and may have no actual direct business relevance. The network view can be made visible to a network administrator role.

Note that as utilized herein, the term “roles” can refer to the roles of entities with different job descriptions within the same organization. For instance, Buyer A may responsible for procuring Part A and this can considered a “role”. Buyer B for Part B may be another role. A manager of Buyer A and Buyer B may be another role. The term “business entities” or a “business entity” can be defined as cross organization entities. For instance a “buyer” can be a business entity working with organization A and a “seller” can be a business entity working with organization B.

FIG. 5 illustrates a schematic diagram depicting a graph module view 174 for a procure-to-pay use-case in accordance with an embodiment. As shown in FIG. 5, five steps or operations are shown including a procurement 1, the name 2 of an entity, order release consent 3, order dispatch pending 4, and price negotiation consent 5.

FIG. 6 illustrates a block diagram depicting guide elements 190 in accordance with an embodiment. The guide elements 190 include elements such as “stakeholder”, “total contracts”, “pending task”, “accept/reject/iterate”, “engagement request”, “verification/kyc”, “negotiation”, “contract”, “contract invocation”, “independent asset addition”, “independent asset deletion”, and “independent asset modification”.

FIG. 7 illustrates a block diagram depicting an engagement dictionary 176 in accordance with an embodiment. The engagement dictionary 176 includes some but not all of the same elements shown in FIG. 6, such as “engagement request” and so on.

FIG. 8 illustrates a block diagram of a network view in accordance with an embodiment. The network view shown in FIG. 8 can be displayed in response to a user selection of the GUI button 203. The network view can display information in section 206 such as related to a particular block, in this example block ID 12. The network view can also display information in section 208 also related to a particular block such as block ID 13, and so on.

Inline visualization as discussed earlier can be used to shown details of all the real-time and the historic business transactions across stakeholders for which there exists or existed a blanket contract. Inline visualization can be divided into three modules in their subsequent sections—Secondary Stakeholder (SS) Module, Asset Module and Contract Invocation Module, which can allow a user to gain drilled down information regarding the transactions through blocks of information for each of the above three subsections.

Since each SS may be linked to an Asset that bounds them to the PS through a contract, these information blocks are overlapping layers that offer the PS the flexibility to visit the other two blocks from any one kind to get real-time and historic information about all transactions.

Elements in an information block may include three sub-sections that can display these three types of Information Blocks respectively: 1) Secondary Stakeholder Block (SSB); 2) Asset Block; and 3) Contract Invocation Block. These blocks can provide the following ability and knowledge to the PS:

Title: The title indicates the type of the information block.

Entity name: Name of the SS or Asset.

Number of contracts: This number indicates the total number of existing contracts between a PS and SS for an Asset.

Number of Contract Invocations: This number indicates the total number of contracts that have been invoked for a given SS.

Contract Invocation Status: The status of the Asset after the contract invocation is showcased in a timeline visualization for real-time tracking.

Number of Assets: This number indicates the number of Assets for an SS.

Asset Price: The price for each Asset from a SS along with the negotiation history.

Inventory level: This level indicates the status of the Asset inventory.

Expiry Date: This is the expiry date for Contracts and expected completion date for Contract Invocations.

Transactions: The last three transactions that have occurred between the PS and SS can be showcased with a link to visit all the historical transactions.

Time-stamp: Each transaction has an associated timestamp, which can determine the ordering of the blocks and the corresponding transactions with each block.

Real-time status: This is a status of actions and transactions occurring between a PS and any SS in a form of a two-dimensional visualization. This visualization can be linked to the graph module 152 in the panoramic visualization.

One of the goals of the disclosed visualization framework is to provide the PS with a detailed understanding of all the on-going activities (in Panoramic Visualization) and Historic activities (in Inline Visualization) in context with the following:

### 1. Updates or Modifications in Contracts

### 2. Updates on Verification/KYC

### 3. Ongoing-Negotiations

### 4. Status of any Order Release

### 5. Any Pending Actions for any Stakeholder

6. Any Pending Approvals with any other Stakeholder

### 7. Any ‘Consent for Engagement’ Rejection

### 8. Network On-boardings

### 9. Payment Updates

The PS, according to his or her preferences, priorities and importance, has the flexibility to see the appropriate information represented in the visualization. For example, the case of Supply-Chain, a Buyer (PS) may have 12 Suppliers (SS) and 2 new on-boardings in his or her network. From the 12 SS, only 3 have Contract Invocations. Thus, according to his or her priorities, he or she can choose to have only the activities of those 3 Suppliers to be reflected in the visualizations, while the others are accessible, but faded out. The buyer may not want to see every new supplier on-boarding to his or her network. But he or she may prefer to see them in the visualizations if they are offering an Asset at a lower price than an active Supplier of that Asset. Activities such as any Pending Approvals, Rejection or Cancellation of order releases, modifications in Price or Order release dates, may be of importance to the Buyer. These can be set to alert the PS by default. These customizations can be offered to the viewer in form of Filters and Configurations, as discussed herein.

Filters can be integrated with the front-end layer and can be provided as controls to the PS in the Inline and Panoramic visualizations, which allows customization in the views.

Primary filters may help the PS to have control over activities he or she would want to see reflecting in the visualizations, such as, for example:

1. Ability to view transactions of a specific Time Range
2. Ability to view transactions for specific Secondary Stakeholder (SS)
3. Ability to view transactions of specific Assets
4. Ability to view specific Action Statuses
5. Ability to view specific Engagement Types

### Secondary Filters

Secondary filters act as a filter layer over the primary filters. They allow the PS to drill down further to specific activities like:
1. SS with Pending Actions
2. Specific type of Pending Actions (e.g. Pending Payments)
3. SS with Pending Approvals
4. Modifications made in the Smart Contract by any Stakeholder

### 5. Negotiations in the Transaction History

Configurations are filters that apply to the back-end layer and can reflect in the front-end layer by default. Configurations are filters that can allow the PS/admin to define the total numbers of stakeholders that can exist on the network, define the contract overflow limit, obtain alerts for a specific “Action Status”, and obtain alerts when an SS updates his or her asset list.

The Panoramic and Inline views can be inter-connected. Interacting with specific elements in both the modules allows a user to seamlessly switch between the visualizations. All elements in the Panoramic View are “clickable” and can lead users to individual sections of the application. These sections can be supported by inline visualizations. The ‘Real-Time Status’ helps users switch back to the Panoramic View. For instance, clicking on a contract invocation engagement can lead users to the order release details for that contract in the Procure-to-Pay use-case.

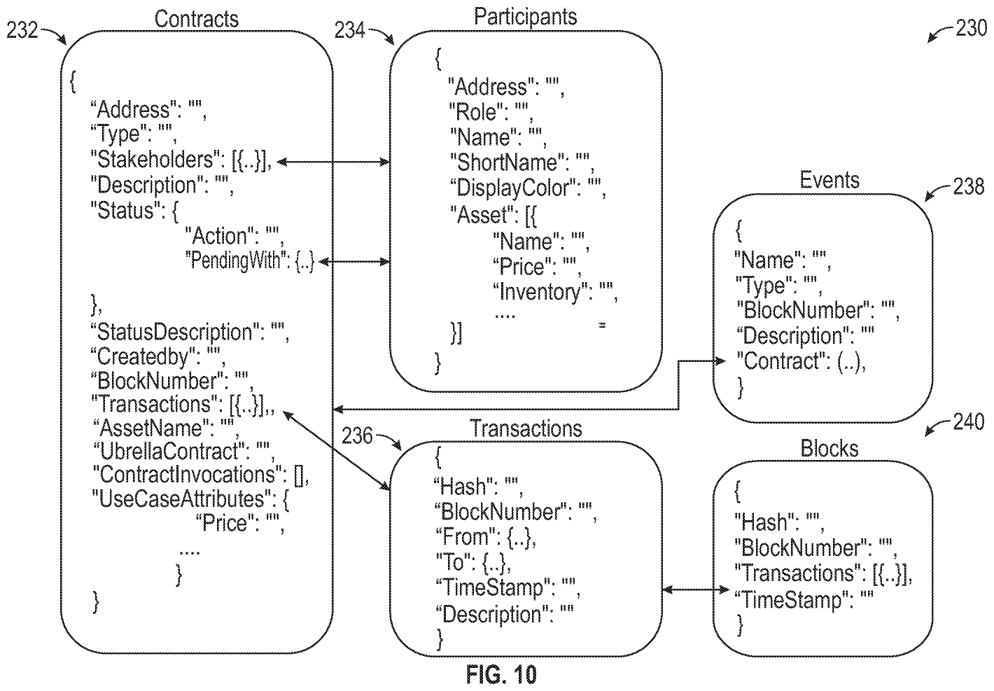

FIG. 9 illustrates a schema 220 for a configuration database in accordance with an embodiment. The schema 220 shown in FIG. 9 includes event configuration 222 (“EventConfig”) and explorer configuration 224 (“ExplorerConfig”). FIG. 10 illustrates a schema 230 for an explorer database in accordance with an embodiment. The schema 230 shown in FIG. 10 involves contracts 232, participants 234, transactions 236, events, 238, and blocks 240.

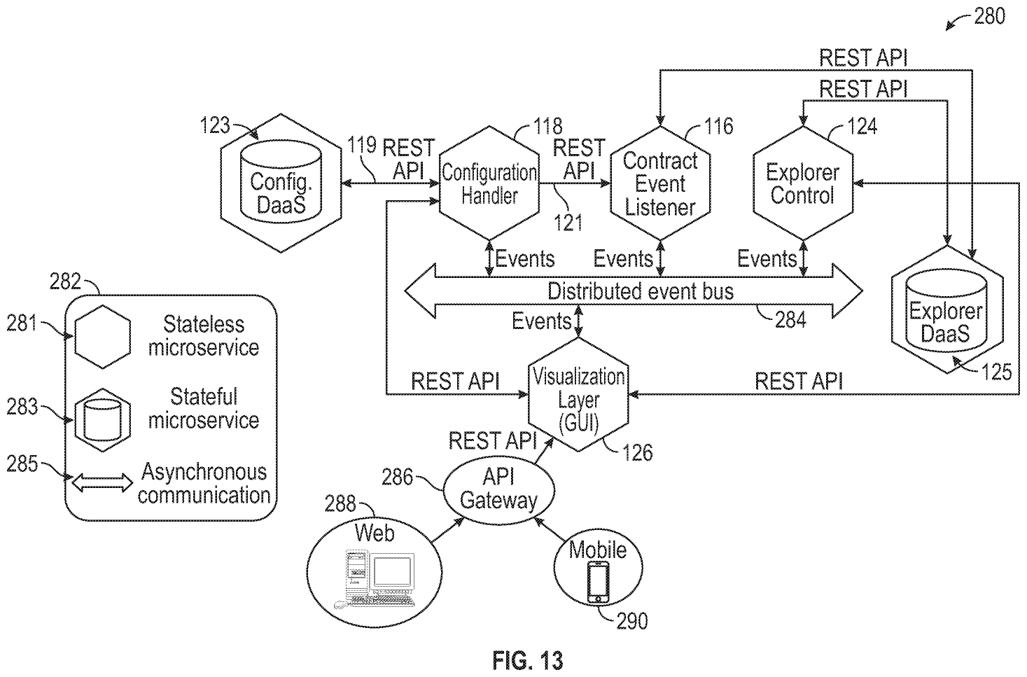

It should be noted that the back-end layer or back-end system 120 shown in FIG. 1 can include modules such as a configuration handler (CH) that can be responsible for augmenting the event listener configuration settings according to the filters chosen by the user in the configuration UI (User Interface). The CH can provide APIs that can be consumed by the Contract Event Listener to start and stop listening to specific events associated with smart contracts. The responsibilities of CH may involve persisting the changes in the configuration settings in the Configuration Data store, and allowing for the addition and the deletion of new event handlers in the Contract Event Listener. An example of a CH is the configuration handler 118 shown in FIG. 1 and FIG. 13.

An Explorer Database (ED) can represent the data obtained from the blockchain platform whose schema 230 is shown in FIG. 10. Typically, this can include information about the blocks, its associated transactions, stakeholders, events part of the smart contracts, etc. In addition to the basic properties, the ED also stores information about use-case specific attributes. For instance, in a supply chain, information such as product price and delivery time may be added as use-case attributes of the Contract. The data from the ED can be responsible for powering the visualization layer 126, which provides for the display of the panoramic view (e.g., in “real time”) and the inline view. An example of an ED is the explorer and configuration database 122 shown in FIG. 1.

The configuration Database (CD) is the database that includes information about the explorer configuration settings such as the number of stakeholders to be displayed on the UI, events for real time notifications, etc. (e.g., see FIG. 9 for the configuration schema). In addition to explorer settings (ExplorerConfig), the user-defined events of interest (EventConfig) can be stored here. An example of a CD is the explorer and configuration database 122 shown in FIG. 1. Note that in the example depicted in FIG. 1, the explorer and configuration database 122 is a combined ED/CD database. In other examples, the ED and CD may be implemented as separate databases such as shown in FIG. 13.

The contract event listener 116 can be implemented as a module that can be responsible for listening to events that are broadcasted in the blockchain network. The events can be associated with contracts (e.g., see FIG. 9) and may have handlers that “listen” to events as listed in the Configuration Database (CD). When there are changes to the filtering options in the explorer module 154, the listeners can be notified (e.g., addition/deletion) and the list of events can be updated accordingly.

The Explorer Controller (EC) can function as a gateway between the Explorer and the Explorer Database (ED). The EC can facilitate a request response approach (i.e. provides APIs for the visualization to communicate with ED, fetch the data, process the data and forwards the response for rendering them on a UI). An example of an EC is the explorer controller 124 shown in FIG. 1 and FIG. 13.

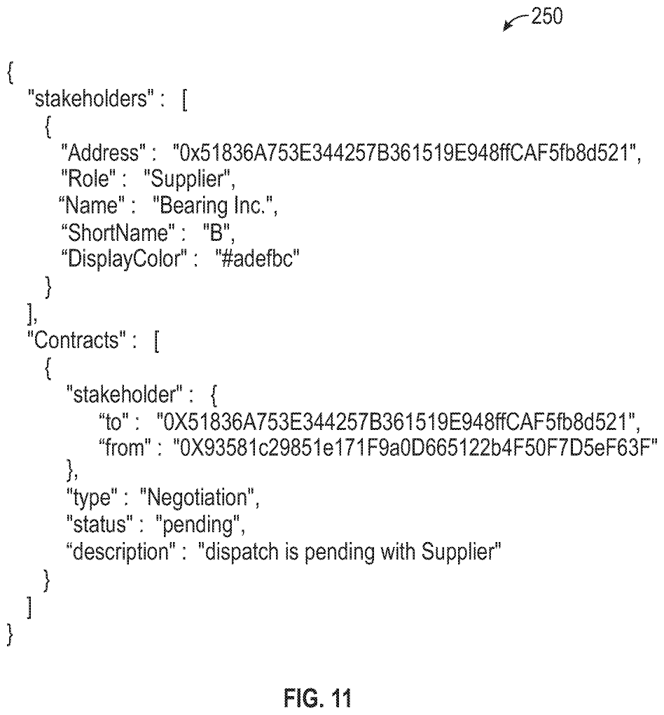

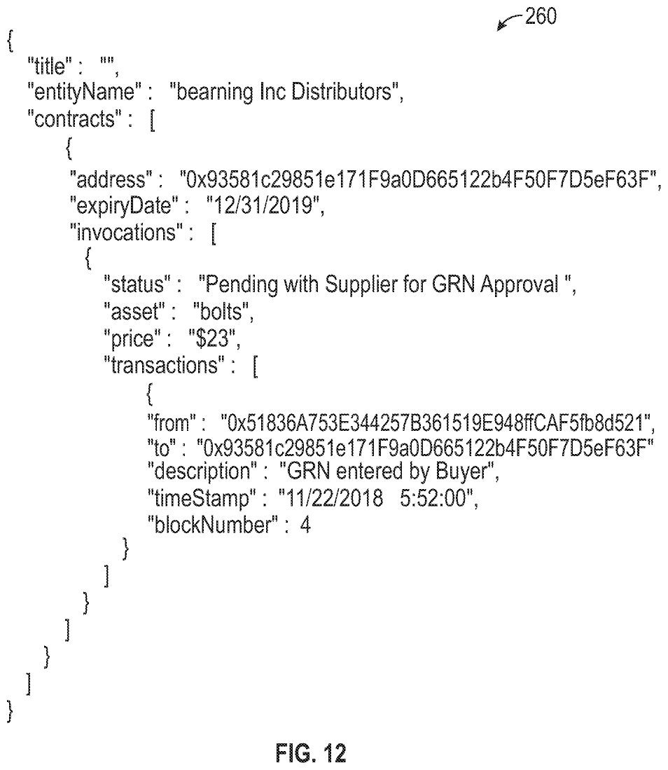

FIG. 11 illustrates API output 250 for a panoramic view in accordance with an embodiment. FIG. 12 illustrates API output 260 for an inline view in accordance with an embodiment. Sample illustration of APIs for Panoramic and Inline views are shown in FIG. 11 and FIG. 12, respectively. For a panoramic view to a graph view, a user specific view is represented, so the input can be that of a stakeholder, and optional filters such as contracts, assets, and secondary stakeholders may be utilized. The output may be in the form of, for example, XML/JSON (JavaScript Object Notation). For an inline view to, for example, the secondary stakeholder module 164 shown in FIG. 2, the input can involve an AIP taking a secondary stakeholder as input, wherein additional filters such as asset, contract type can also be defined. The output may also be in the form of XML/JSON.

FIG. 13 illustrates a block diagram depicting the deployment of a visualization system 280 in accordance with an alternative embodiment. The visualization system 280 shown in FIG. 13 is an alternative embodiment of the visualization system 100 shown in FIG. 1. The visualization system 280 can include a configuration DaaS (Desktop-as-Service) 123 that communicates bidirectionally with the configuration handler 118. The configuration DaaS may include a configuration database, which in turn can communicate via a distributed event bus 284 with the contract event listener 116 and the explorer controller 124. An explorer DaaS can communicate bidirectionally with the explorer controller 123 and the contract event listener 116.

Note that DaaS (Desktop-as-a-service) can relate to a form of VDI (Virtual Desktop Infrastructure) in which the VDI may be outsourced and handled by a third party. Also referred to hosted desktop services, desktop-as-a-service can be implemented as a cloud service along with apps, which may be needed for use on the virtual desktop.

The visualization system 280 can also include the visualization layer 126, which communicates with an API gateway 286, which in turn can communicate bidirectionally via a data communications network (wireless and/or wired) with a remote computing device 288 (e.g., personal computer, server, desktop computer, a server, etc.) and a mobile communications device (e.g., a smartphone, tablet computing device, etc.).

The visualization system 280 can also include or incorporate the use of a microservices-based application 282, which can include a stateless microservice 281 and/or a stateful microservice 283, along with asynchronous communications 285. The stateless microservice 281 can be provided by a stateless application and the stateful microservice 283 can be facilitated by a stateful application. An important distinction between stateful and stateless applications is that stateless applications do not “store” data, but stateful applications require backing storage. Stateful applications like the Cassandra, MongoDB and mySQL databases all require some type of persistent storage that will survive service restarts.

The Explorer framework can be enabled with reusable components designed as the stateful (e.g., Explorer, Configuration DaaS) microservice 283 and the stateless (e.g., Configuration handler, Explorer Controller) micro-service 281. As shown in FIG. 13, there are two modes of communication namely a) synchronous mode using REST APIs; and b) asynchronous mode using a publish/subscribe model. A REST API 119 and a REST API 121 can be predominantly used for external communication for instance, between Explorer and Controller while the latter can be used to facilitate data exchange between the internal modules (components) (e.g., Explorer and Explorer Database, Configuration Handler and Configuration Data store).

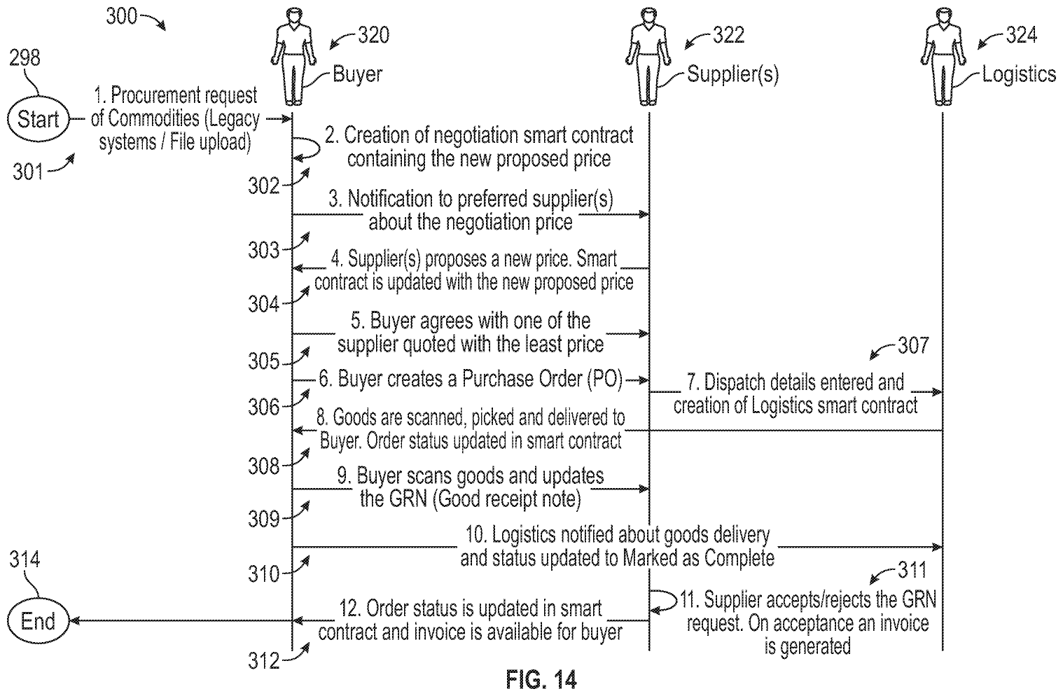

FIG. 14 illustrates a schematic diagram of a negotiation process flow for a procure-to-pay use case 300 in accordance with an embodiment. In the example shown in FIG. 14, the major stakeholders in the Procure-to-Pay use-case 300 may be a buyer 320, a supplier 322 and logistics 324. The buyer 320 can initiate a procurement request to the supplier 322, which if accepted by the supplier 322, may lead to a series of business transactions before the buyer 320 receives the goods and proceeds with the payment.

The process flow diagram shown in FIG. 14 illustrates an end-to-end procure-to-pay journey with the buyer 320 as the primary stakeholder. As shown in FIG. 14, the process can begin, as indicated at block 298. As depicted next at step 301, a procurement request of commodities (e.g., legacy systems/filed uploads) can be made. Next, as indicated at step 302, a negotiated smart contract can be created, which can contain a new proposed price. Thereafter, as indicated at step 303, an electronic notification can be sent (e.g., via an e-mail message, a text message and so on) to a preferred supplier(s) regarding the negotiation price. In some instances, the preferred supplier(s) may be the supplier 322.

As shown next at step 304, the supplier(s) can propose a new price and the smart contract can be updated with the new proposed price. Then, as depicted at step 305, the buyer 320 can agree with a supplier's quoted lowest price. Thereafter, as illustrated at step 306, the buyer 320 can create a PO (Purchase Order). Next, as described at step 307, an operation can be implemented in which details are dispatched regarding the PO to logistics 324 and a smart contract with respect to logistics 324 is created. Then, as indicated at step 308, goods can be scanned and picked up and delivered to the buyer 320. The order status can also be updated in the smart contract.

Next, as shown at step 309, the buyer 320 can scan goods and update a related GRN (Goods Receipt Note). Thereafter, as depicted at step 310, logistics 324 can be notified about the goods delivery and a status updated to “marked as complete”. Then, as depicted at step 311, the supplier 322 can accept or reject the GRN request. Upon acceptance and invoice can be generated. Thereafter, as indicated at step 312, the order status can be updated in the smart contract and the invoice is now available for the buyer 320. The process can then end, as shown at block 314.

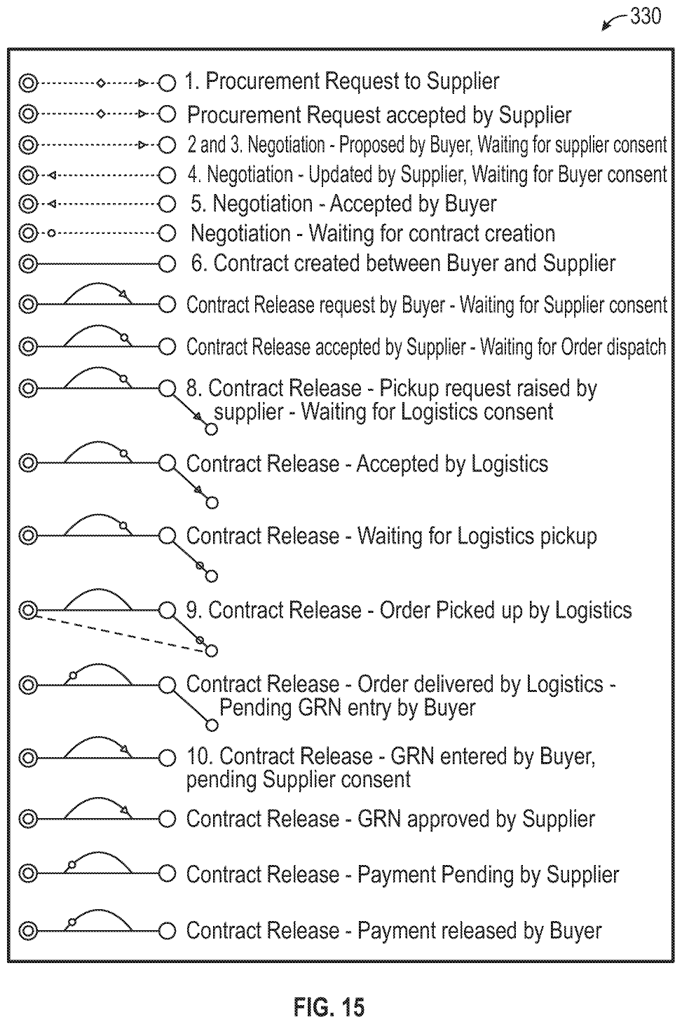

FIG. 15 illustrates a visual representation 330 of a procure-to-pay process flow in accordance with an embodiment. FIG. 15 depicts transactions in a visual sequence. Elements of the visual sequence can include highlighting different action statuses and engagement types defined in the panoramic visualization section. An attempt has been made with FIG. 15 to include all the different states of visualization within the process flow to provide an essence of the dynamic nature of the disclosed visualization.

The disclosed example embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of, for example, a general-purpose computer, special-purpose computer, or other programmable data processing apparatus to produce a machine, such that the instructions, which execute via the processor of the computer or other programmable data processing apparatus, create means for implementing the functions/acts specified in the block or blocks.

To be clear, the disclosed embodiments can be implemented in the context of, for example a special-purpose computer or a general-purpose computer, or other programmable data processing apparatus or system. For example, in some example embodiments, a data processing apparatus or system can be implemented as a combination of a special-purpose computer and a general-purpose computer. In this regard, a system composed of different hardware and software modules and different types of GUI features may be considered a special-purpose computer designed with the specific purpose of rendering a blockchain visualization. In general, embodiments may be implemented as a method, and/or a computer program product at any possible technical detail level of integration. The computer program product may include a computer readable storage medium (or media) having computer readable program instructions thereon for causing a processor to carry out aspects of the embodiments.

The aforementioned computer program instructions may also be stored in a computer-readable memory that can direct a computer or other programmable data processing apparatus to function in a particular manner, such that the instructions (e.g., steps/operations) stored in the computer-readable memory produce an article of manufacture including instruction means which implement the function/act specified in the various block or blocks, flowcharts, and other architecture illustrated and described herein.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

The flow charts and block diagrams in the figures illustrate the architecture, functionality, and operation of possible implementations of systems, methods, and computer program products according to various embodiments (e.g., preferred or alternative embodiments). In this regard, each block in the flow chart or block diagrams may represent a module, segment, or portion of instructions, which comprises one or more executable instructions for implementing the specified logical function(s).

In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The functionalities described herein may be implemented entirely and non-abstractly as physical hardware, entirely as physical non-abstract software (including firmware, resident software, micro-code, etc.) or combining non-abstract software and hardware implementations that may all generally be referred to herein as a “circuit,” “module,” “component,” “block”, “database”, “agent” or “system.” Furthermore, aspects of the present disclosure may take the form of a computer program product embodied in one or more non-ephemeral computer readable media having computer readable and/or executable program code embodied thereon.

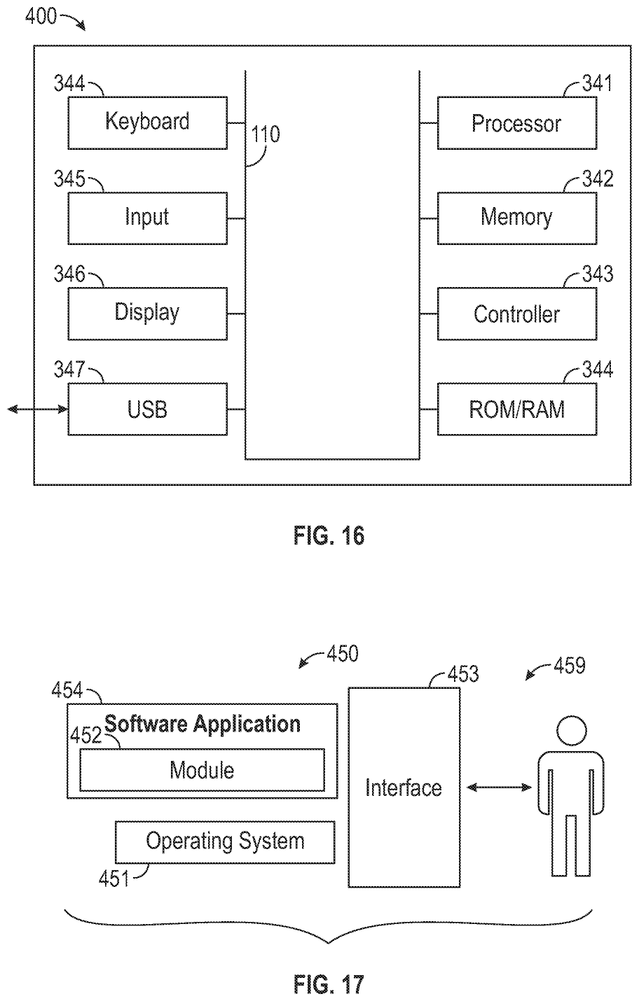

FIGS. 16-17 are shown only as exemplary diagrams of data-processing environments in which example embodiments may be implemented. It should be appreciated that FIGS. 16-17 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 16, some embodiments may be implemented in the context of a data-processing system 400 that can include, for example, one or more processors such as a processor 341 (e.g., a CPU (Central Processing Unit) and/or other microprocessors), a memory 342, a controller 343, additional memory such as ROM/RAM 332 (i.e. ROM and/or RAM), a peripheral USB (Universal Serial Bus) connection 347, a keyboard 344 and/or another input device 345 (e.g., a pointing device, such as a mouse, track ball, pen device, etc.), a display 346 (e.g., a monitor, touch screen display, etc) and/or other peripheral connections and components.

The system bus 110 serves as the main electronic information highway interconnecting the other illustrated components of the hardware of data-processing system 400. In some embodiments, the processor 341 may be a CPU that functions as the central processing unit of the data-processing system 400, performing calculations and logic operations required to execute a program. Such a CPU, alone or in conjunction with one or more of the other elements disclosed in FIGS. 1-2 and/or FIGS. 15-16, is an example of a production device, computing device or processor. Read only memory (ROM) and random access memory (RAM) of the ROM/RAM 344 constitute examples of non-transitory computer-readable storage media.

The controller 343 can interface with one or more optional non-transitory computer-readable storage media to the system bus 110. These storage media may include, for example, an external or internal DVD drive, a CD ROM drive, a hard drive, flash memory, a USB drive or the like. These various drives and controllers can be optional devices. Program instructions, software or interactive modules for providing an interface and performing any querying or analysis associated with one or more data sets may be stored in, for example, ROM and/or RAM 344. Optionally, the program instructions may be stored on a tangible, non-transitory computer-readable medium such as a compact disk, a digital disk, flash memory, a memory card, a USB drive, an optical disc storage medium and/or other recording medium

As illustrated, the various components of data-processing system 400 can communicate electronically through a system bus 351 or similar architecture. The system bus 351 may be, for example, a subsystem that transfers data between, for example, computer components within data-processing system 400 or to and from other data-processing devices, components, computers, etc. The data-processing system 400 may be implemented in some embodiments as, for example, a server in a client-server based network (e.g., the Internet) or in the context of a client and a server (i.e., where aspects are practiced on the client and the server).

In some example embodiments, data-processing system 400 may be, for example, a standalone desktop computer, a laptop computer, a Smartphone, a pad computing device and so on, wherein each such device is operably connected to and/or in communication with a client-server based network or other types of networks (e.g., cellular networks, Wi-Fi, etc). An example of a mobile computing device implementation of the data-processing system 400 is the mobile computing device 290 shown in FIG. 13. An example of a remote computing device implementation of the data-processing system 400 is the remote computing device 288 also shown in FIG. 13.

FIG. 17 illustrates a computer software system 450 for directing the operation of the data-processing system 400 depicted in FIG. 16. The software application 454, stored for example in memory 342 and/or another memory, generally includes one or more modules such as module 452. The computer software system 450 also includes a kernel or operating system 451 and a shell or interface 453. One or more application programs, such as software application 454, may be “loaded” (i.e., transferred from, for example, mass storage or another memory location into the memory 342) for execution by the data-processing system 400. The data-processing system 400 can receive user commands and data through the interface 453; these inputs may then be acted upon by the data-processing system 400 in accordance with instructions from operating system 451 and/or software application 454. The interface 453 in some embodiments can serve to display results, whereupon a user 459 may supply additional inputs or terminate a session. The software application 454 can include module(s) 452, which can, for example, implement instructions or operations such as those discussed herein (e.g., the instructions/operations of method 70 shown at blocks 72 to 86 in FIG. 7 and elsewhere herein). Module 452 may also be composed of a group of modules.

The following discussion is intended to provide a brief, general description of suitable computing environments in which the system and method may be implemented. Although not required, the disclosed embodiments will be described in the general context of computer-executable instructions, such as program modules, being executed by a single computer. In most instances, a “module” can constitute a software application, but can also be implemented as both software and hardware (i.e., a combination of software and hardware).

Generally, program modules include, but are not limited to, routines, subroutines, software applications, programs, objects, components, data structures, etc., that perform particular tasks or implement particular data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

In some example embodiments, the term “module” can also refer to a modular hardware component or a component that is a combination of hardware and software. Examples of modules include the various modules such as the configuration handler 118, the event listener 116, the explorer controller 124, the visualization layer 125, and so on, depicted in FIG. 1. Other examples of modules include the customization module 142, the panoramic visualization module 150, the inline visualization module 160, the graph module 152, the explorer module 154, the contract invocation module 162, the asset module 166, the secondary stakeholder module 164, and so on, illustrated in FIG. 2. It should be appreciated that processing of such modules according to the approach described herein can lead to improvements in processing speed and ultimately in energy savings and efficiencies in a data-processing system such as, for example, the data-processing system 400 shown in FIG. 15. A module can perform the various steps, operations or instructions discussed herein.

Note that the visualization layer 126, for example, can constitute an improvement to a computer system (e.g., such as the data-processing system 400 shown in FIG. 16) rather than simply the use of the computer system as a tool. The visualization layer 126 along with the other modules, instructions and functionalities discussed herein can result in a specific improvement over prior systems, resulting in an improved user interface for electronic devices including data-processing systems. Such an improved user interface facilitates a dynamic visualization of blockchain transactions and assets for users, in a manner not available in prior visualization mechanisms.

FIGS. 16-17 are intended as examples and not as architectural limitations of disclosed embodiments. Additionally, such embodiments are not limited to any particular application or computing or data processing environment. Instead, those skilled in the art will appreciate that the disclosed approach may be advantageously applied to a variety of systems and application software. Moreover, the disclosed embodiments can be embodied on a variety of different computing platforms, including Macintosh, UNIX, LINUX, and the like.

It is understood that the specific order or hierarchy of steps, operations, or instructions in the processes or methods disclosed is an illustration of exemplary approaches. For example, the various steps, operations or instructions discussed herein can be performed in a different order. Similarly, the various steps and operations of the disclosed example pseudo-code discussed herein can be varied and processed in a different order. Based upon design preferences, it is understood that the specific order or hierarchy of such steps, operation or instructions in the processes or methods discussed and illustrated herein may be rearranged. The accompanying claims, for example, present elements of the various steps, operations or instructions in a sample order, and are not meant to be limited to the specific order or hierarchy presented.

The inventors have realized a non-abstract technical solution to the technical problem to improve a computer-technology by improving efficiencies in such computer technology. The disclosed embodiments offer technical improvements to a computer-technology such as a data-processing system, and further provide for a non-abstract improvement to a computer technology via a technical solution to the technical problem(s) identified in the background section of this disclosure. The ability to provide a visualization of blockchain transactions in a fast and efficient manner can lead to improved efficiencies such as in memory management and processing in the underlying computer technology. The visualization framework disclosed herein provides the benefits of a more seamless GUI implementation along with faster searching of databases and more efficient data storage. Such improvements can result from implementations of the disclosed embodiments. The claimed solution may be rooted in computer technology in order to overcome a problem specifically arising in the realm of computers, computer networks and blockchain platforms.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method for visualizing a distributed ledger data structure, comprising:
identifying transactions and assets in ledger data contained in a ledger data structure; and
translating the identified transactions and the identified assets into visual elements that visually represent asset states in a process involving the ledger data structure.

2. The method of claim 1 further comprising creating the transactions utilizing a smart contract.

3. The method of claim 1 wherein the process comprises a flow of assets involving the identified transactions between at least two entities.

4. The method of claim 3 wherein the visual elements further represent the at least two stakeholders across different roles and organizations.

5. The method of claim 1 further comprising permitting a user to interact with different visual elements among the visual elements.

6. The method of claim 5 wherein the user is permitted to interact with different visual elements among the visual elements based on at least one query supplied by the user.

7. The method of claim 5 wherein the user is permitted to interact with different visual elements among the visual elements without supplying a query.

8. The method of claim 1 further comprising:
dynamically representing the identified transactions and the identified assets in a visualization layer; and
updating the visualization layer in real-time to capture a change in a state of the identified assets.

9. The method of claim 1 wherein the identified transactions are use-case agnostic.

10. The method of claim 1 wherein the identified transactions are generic across blockchain platforms.

11. The method of claim 10 further comprising configuring an event listener to function as a gateway to the blockchain platforms, wherein the event listener performs in a platform agnostic manner with respect to the blockchain platforms.

12. A system for visualizing a distributed ledger data structure, comprising:
a ledger data structure, wherein transactions and assets are identified in ledger data contained in the ledger data structure; and
visual elements displayed in a user interface, wherein the identified transactions and the identified assets are translated into the visual elements, which visually represent asset states in a process involving the distributed ledger data structure.

13. The system of claim 12 further comprising creating the transactions utilizing a smart contract.

14. The system of claim 12 wherein the process comprises a flow of assets involving the identified transactions between at least two stakeholders and wherein the visual elements further represent the at least two stakeholders across different roles and organizations.

15. The system of claim 12 wherein a user is permitted to interact with different visual elements among the visual elements via the user interface.

16. The system of claim 15 wherein the user is permitted to interact with different visual elements among the visual elements based on at least one query supplied by the user or without supplying a query.

17. The system of claim 12 wherein the user interface comprises a visualization layer wherein the identified transactions and the identified assets are dynamically visualized and wherein the visualization layer is updated in real-time to capture a change in a state of the identified assets.

18. The system of claim 12 wherein the identified transactions are use-case agnostic and generic across blockchain platforms and wherein the system further comprises an event listener that functions as a gateway to the blockchain platforms, wherein the event listener performs in a platform agnostic manner with respect to the distributed ledger data structure.

19. A system for visualizing a ledger data structure, comprising:
at least one processor and a memory, the memory storing instructions to cause the at least one processor to perform:
identifying transactions and assets in ledger data contained in a ledger data structure; and
translating the identified transactions and the identified assets into visual elements that visually represent asset states in a process involving the ledger data structure.

20. The system of claim 19 wherein the instructions are further configured to cause the at least one processor to perform: creating the transactions utilizing a smart contract.
